(19) United States
(12) Patent Application Publication
(10) Pub. No.: US 2014/0087579 A1
(43) Pub. Date: Mar. 27, 2014

(54) CONNECTOR COMPONENT AND PORTABLE ELECTRONIC DEVICE HAVING THEREOF

(71) Applicants: INVENTEC (PUDONG) TECHNOLOGY CORPORATION, Shanghai (CN); INVENTEC CORPORATION, Taipei (TW)

(72) Inventor: Chien-Hung Chen, Taipei (TW)

(73) Assignees: INVENTEC CORPORATION, Taipei (TW); Inventec (Pudong) Technology Corporation, Shanghai (CN)

(21) Appl. No.: 13/799,136

(22) Filed: Mar. 13, 2013

(30) Foreign Application Priority Data
Sep. 25, 2012 (CN) 201210362927.0

(51) Int. Cl. H01R 13/622

(52) U.S. Cl. CPC H01R 13/622
USPC 439/345

(57) ABSTRACT

A connector component that is used for connecting a first electronic device and a second electronic device via the connector component is provided. The connector component includes a first connection component, a second connection component and fixing element. The first connection component electronically extends from the first electronic device and has a fastening portion. The second connection component is disposed in the second electronic device. The fixing element is disposed in the second electronic device and is located next to the second connection component. When the first connection component is coupled to the second connection component, the fixing element is fastened with the fixing portion, so as to fix the first connection component to the second connection component.

### CROSS-REFERENCE TO RELATED APPLICATIONS

This non-provisional application claims priority under 35 U.S.C. §119(a) on Patent Application No(s). 201210362927.0 filed in China, P.R.C. on Sep. 25, 2012, the entire contents of which are hereby incorporated by reference.

### TECHNICAL FIELD OF THE INVENTION

The disclosure relates to a connector component, more particularly to a portable electronic device having thereof

### DESCRIPTION OF THE RELATED ART

As the technology improves and the notebook becomes commonplace, more and more people are used to surfing the internet, processing files, playing videos or storing data by using notebooks. Therefore, notebooks have become essential to daily life these days. In the circuit board of the notebook, there are a variety of electronic components that perform different functions. For instance, there are some sockets in the circuit board that are used for connecting, for example, a keyboard, a mouse and a monitor, so as to benefit the application of the notebook.

The design of the notebook, however, features in a slim design and a small size nowadays. Thereby, the depth of the connection between the socket and the plug is reduced, and thereby leads to an unstable condition. As a result, this unstable condition may be detrimental to the quality of the signal transmission.

### SUMMARY OF THE INVENTION

In an embodiment, the disclosure provides a connector component configured for connecting a first electronic device and a second electronic device via the connector component. The connector component comprises a first connection component, a second connection component and a fixing element. The first connection component electronically extends from the first electronic device and has a fastening portion. The second connection component is disposed in the second electronic device. The fixing element is disposed in the second electronic device and is located next to the second connection component. When the first connection component is coupled to the second connection component, the fixing element is fastened with the fixing portion, so as to fix the first connection component to the second connection component.

The disclosure further provides a portable electronic device configured for connecting an exterior device in order to perform data transmission. The exterior device has a first connection component. The first connection component has at least one fastening portion. The portable electronic device comprises a case, a second connection component and at least one fixing element. The second connection component is disposed in the case. The at least one fixing element is disposed in the case and next to the second connection component. When the exterior device is connected with the second connection component by the first connection component, the fixing element is fastened with the fastening portion.

### BRIEF DESCRIPTION OF THE DRAWINGS

The disclosure will become more fully understood from the detailed description given herein below for illustration only and thus does not limit of the disclosure, wherein:

FIG. 1 is a perspective view of a portable electronic device and an exterior device according to an embodiment of the disclosure;

FIG. 2 is a sectional view of a portable electronic device and a exterior device according to an embodiment of the disclosure; and

FIG. 3 is a perspective view of a plug of the exterior device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known components and devices are schematically shown in order to simplify the drawing.

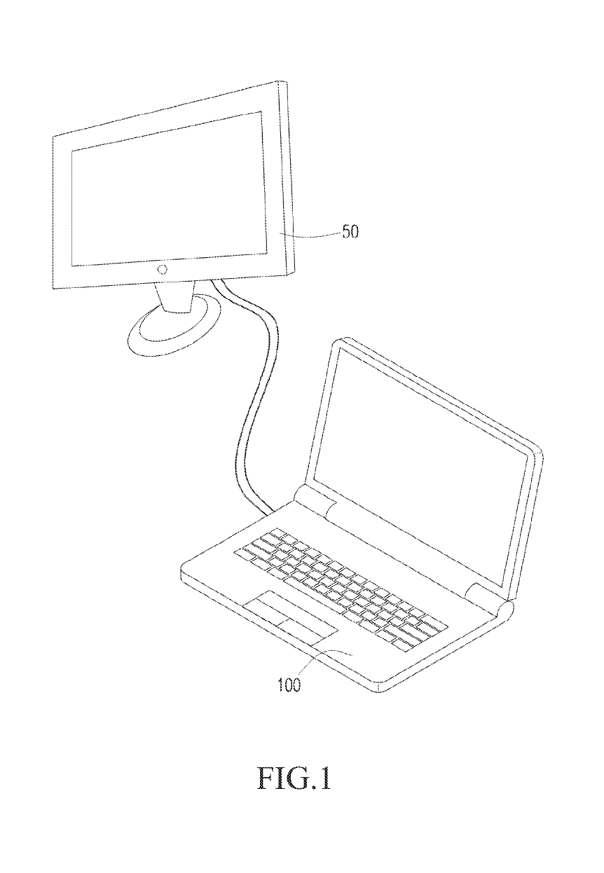

FIG. 1 is a perspective view of a portable electronic device and an exterior device according to an embodiment of the disclosure. Referring to FIG. 1, the portable electronic device 100 is configured for connecting an exterior device 50, so as to perform data transmission.

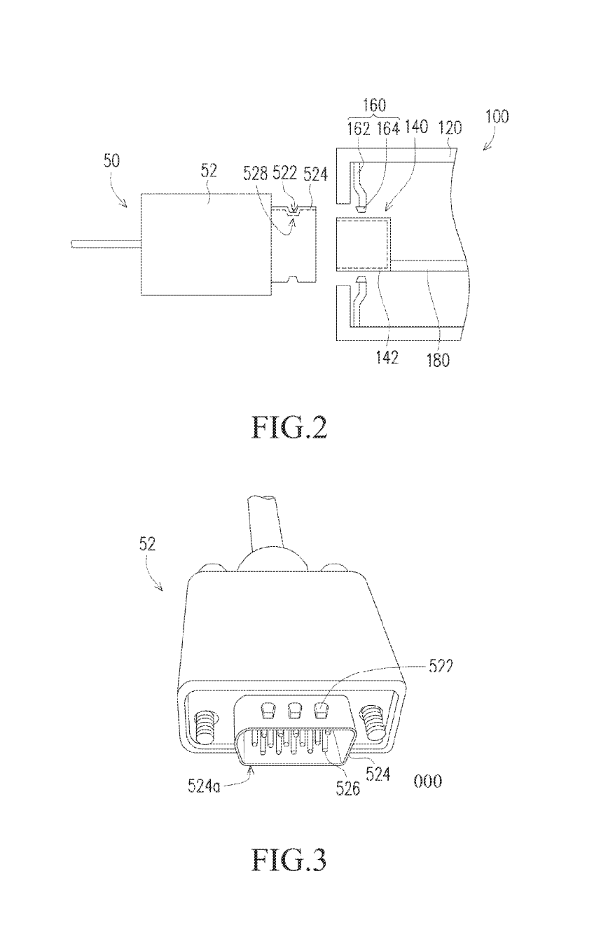

Please refer to FIG. 2, which is a sectional view of a portable electronic device and an exterior device according to an embodiment of the disclosure. Specifically, the exterior device 50 has a first connection component 52 and the first connection component 52 has at least one fastening portion 522. The portable electronic device 100 comprises a case 120, a second connection component 52 and at least one fixing element 160. The second connection component 140 is disposed in the case. The at least one fixing element is disposed next to the second connection structure 140. In this embodiment, the second connection component is disposed on the circuit board 180 of the case 120, but the disclosure is no limited thereto. When the exterior device 50 passes through the first connection structure 52 and connect to the second connection component 140, the fixing element 160 is fastened with the fastening portion 522, so as to fix the first connection structure 52 to the second connection structure 140. Moreover, after the first connection component 52 connects to the second connection component 140, the exterior device 50 is configured for plugging in the portable electronic device 100 stably due to the connection between the fixing component 160 of the portable electronic device 100 and the fastening portion 522 of the first connection component 52. In the mean time, the quality of the data transmission between the portable electronic device 100 and the exterior device 50 is able to be improved.

In this embodiment, the exterior device 50 is a monitor, a projector or other similar electronic devices. When the portable electronic device 100 is connected with the exterior device 50, the data transmission between them can be performed. For example, the video transmission can be performed. For instance, the portable electronic device 100 is a notebook while the exterior device 50 is a projector. After they are connected with each other via the first connection component 52 and the second connection component 140, the video data of the notebook is configured for being transmitted to the projector and then is configured for being projected via the projector. Alternatively, as shown in the FIG. 1, the exterior device 50 is a monitor and the portable electronic device 100 is a notebook. When they are connected with each other, the display of the notebook can also be shown on the monitor synchronously.

Please refer to FIG. 2. In this embodiment, case 120 and the fixing element 160 of the portable electronic device 100 are formed as a single unit. For instance, the case 120 is made from the plastic material. The fixing element 160 and the case 120 are manufactured through the injection molding process. Specifically, the fixing element 160 comprises an elastic arm 162 and a hook 164. One end of the elastic arm 162 is fixed to the case 120, while the other end is connected with the hook 164. In this embodiment, the hook 164 is similar to a conic structure, while the elastic arm 162 is the extending part of the inner edge extending towards the second connection component 140.

Furthermore, the elastic arm 162 is configured for contributing resilience to the fixing component 160 when the first connection structure 52 is plugged in the second connection component 140. After the first connection component 52 is plugged in the second connection component 140, the hook 164 is configured for extending to the indentation of the fastening portion 522 and thus being fixed to the indentation. Thereby, the connection between the portable electronic device and the exterior device 50 is more stable.

FIG. 3 is a perspective view of a plug of the exterior device according to an embodiment of the disclosure. The first connection component 52 and the second connection component 140 are substantially VGA connectors configured for transmitting video between the portable electronic device 100 and the exterior device 50. The first connection structure 52 is the male connector of the VGA connector while the second connection component 140 is the female connector of the VGA connector. Nevertheless, in other embodiments, other connectors may be utilized for connecting the first connection component 52 and the second connection component 140, so the disclosure is not limited thereto. Please refer to FIG. 3. Specifically, the first connection component has a first connection groove 524 configured for connecting to the portable electronic device 100. After the first connection structure 52 is plugged in the portable electronic device 100, the first connection groove 524 is configured for surrounding a second connection groove 142 the second connection component 140 (as shown in FIG. 2). As shown in FIG. 3, a plurality of indentations are disposed on the exterior surface of the first connection groove 524, and the fastening portion 522 is substantially an indentation on the exterior surface of the first connection groove 524. After the first connection component 52 is plugged into the portable electronic device 100, the fixing element 160 is fastened with the indentations. Moreover, the first connection component further has a plurality of terminals. After the first connection component 52 is plugged into the portable electronic device 100, the terminals 526 are configured for contacting and electronically connecting to the second connection component 140, so as to transmit the data signal between the portable electronic device 100 and the exterior device 50.

Please refer to FIG. 3. In this embodiment, the first connection structure 52 has six fastening portions 522 but only three of the fastening portions 522 are shown due to the visual angle. The other three fastening portions 522 are located on the other surface 524a opposite to the first connection groove 524. Furthermore, to conform to the quantity of the fastening portion 522 of the first connection component 52, the portable electronic device 100, in this embodiment, has six fixing elements 160. In FIG. 2, however, only two of the six fixing elements 160 are schematically shown. The quantities and locations of the fixing element 160 and the fastening portion 522 are not intended to limit the disclosure, and the users may modify them according to the requirements, to achieve the purpose of the stable connection between the exterior device 50 and the portable electronic device 100. Also, the location of the fastening portion 522 in FIG. 3 is not intended to limit the disclosure, so the fastening portion 522 may be located at any surface of the external side of the first connection groove 524.

Please refer to FIG. 2. In this embodiment, at least one protrusion part 528 is further disposed on the inner surface of the first connection groove 524 of the fastening portion 522. In this embodiment, the protrusion part 528 corresponds to the indentation, namely the fastening portion 522. Additionally, the protrusion part 528 is configured for contacting and connecting to the second connection groove 142 after the first connection component 52 is plugged into the portable electronic device 100. Thereby, a stable connection between them can be achieved.

According to the above-mentioned embodiments, in the connector component of the disclosure, the first connection component has the fastening portion, and the second connection component is surrounded by the corresponding fixing elements. When the first connection component is plugged into the second connection component, the fastening portion is configured for fastening with the fixing element, and this leads to a stable connection between the electronic device having the second connection structure and the device having the first connection component.

Furthermore, as the trend for a slim design of the electronic device becomes more popular, the size of the connection component, used for being connected with the exterior device, reduces accordingly. Under the situation that the size of the product has been reduced, the area used for connection is therefore limited. The application of the disclosure, however, can achieve a stable connection between connection components even though the area used for connection is limited. Consequently, the electronic connection is secured due to the stable connection and the reliability of data transmission is thereby improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A connector component configured for connecting a first electronic device and a second electronic device via the connector component, the connector component comprising:
a first connection component, electronically extending from the first electronic device, the first connection structure has a fastening portion;
a second connection component disposed in the second electronic device; and
a fixing element disposed in the second electronic device and located next to the second connection component, wherein when the first connection component is coupled to the second connection component, the fixing element is fastened with the fixing portion so as to fix the first connection component to the second connection component.

2. The connector component according to claim 1, wherein the first connection component further comprises a first connection groove, the second connection component comprises a second connection groove, the first connection grove is configured for connecting and surrounding the second connection groove, a indentation of the fastening portion is formed at the outer surface of the first groove, and the fixing element is fixed to the indentation.

3. The connector component according to claim 2, wherein the fastening portion further has a protrusion part disposed at the inner surface of the first connection groove, the protrusion corresponds to the indentation and is configured for contacting and connecting with the second connection groove.

4. The connector component according to claim 1, wherein the fixing element and the case of the second electronic device are formed as a single unit, and one end of the fixing element is connected with the case and the other end of the fixing element is a conic component.

5. The connector component according to claim 1, wherein the first connection component and the second connection component are the male end and the female end of the VGA connector respectively.

6. A portable electronic device configured for connecting an exterior device in order to perform data transmission , the exterior device having a first connection component, the first connection component having at least one fastening portion, the portable electronic device comprising:
a case;
a second connection component disposed in the case; and
at least one fixing element disposed in the case and next to the second connection component, wherein when the exterior device is connected with the second connection component by the first connection component, the fixing element is fastened with the fastening portion.

7. The portable electronic device according to claim 6, wherein the first connection component further comprises a first connection groove, the second connection component comprises a second connection groove, the first connection groove is configured for connecting and surrounding the second connection groove, the fastening portion has a indentation located at the exterior surface of the first connection groove, and the fixing element is fixed to the indentation.

8. The portable electronic device according to claim 7, wherein a protrusion part of the fastening portion is further disposed at the inner surface of the first connection groove, and the protrusion part corresponds to the indentation and is configured for contacting and connecting with the second connection groove.

9. The portable electronic device according to claim 6, wherein the fixing element and the case are formed as a single unit, and one end of the fixing element is connected with the case and the other end of the fixing element is a conic component.

10. The portable electronic device according to claim 6, wherein the first connection component and the second connection component are the male end and the female end of the VGA connector respectively.
